(19) United States
(12) Patent Application Publication
(10) Pub. No.: US 2002/0019772 A1
(43) Pub. Date: Feb. 14, 2002

(54) Electronic purchasing system and method

(76) Inventors: Brian M. Hillier, Sydney (CA); Annette P. Boutilier, Sydney (CA); Donald F. Carmichael, Sydney (CA); Carla S. Carmichael, Sydney (CA)

Correspondence Address: Paul Sharpe, Marks & Clerk, Station B, P.O. Box 957, Ottawa, ON, K1P 5S7, CA

(21) Appl. No.: 09/892,615

(22) Filed: Jun. 28, 2001

Related U.S. Application Data
(60) Provisional application No. 60/214,735, filed on Jun. 29, 2000.

(51) Int. Cl. G06F 17/60

(52) U.S. Cl. 705/14; 705/19; 705/39

(57) ABSTRACT

A method for rewarding consumers is disclosed. The method relates to electronic purchasing where a customer is provided with a card having programmed information about the customer therein. The customer presents its card to a merchant at a point of sale for reading the user information. A central register having user information stored therein is connected to a network of merchants. The merchants banking information is accessible in the central register so that when a customer purchases a good or service, the customer is credited or debited points in real time. This information is forwarded to the central register through the card reader and the merchant is simultaneously, in real time, debited a predetermined percentage of the taxed value of the purchase.

### FIELD OF THE INVENTION

The present invention relates to an electronic purchasing system and method and more particularly, the present invention relates to a method of accruing credits or value from purchasing goods and services from merchants where the value is a non-cash value and can be used to electronically purchase other goods and services.

### BACKGROUND OF THE INVENTION

Online purchasing or other forms of electronic purchasing have been previously proposed and are now wide spread in the art. One form of consumers receiving benefit from purchases is the airmiles program. By this system, merchants participating in the airmiles program allow airmile accrual to a cardholder from purchases of goods and services from venders participating in the airmiles program. The user simply provides his or her card to the vender and the vender swipes the card through a conventional card reader well known in the art and allotted points for the purchase are stored in the users file and may be accessed by the user to obtain airline tickets. No cash value is awarded for the credits or value of the points, but rather the points are simply accrued and may be cashed in by a user to obtain a ticket, or other preselected items. The points have no cash value and may not be used to discount or entirely purchase any good or service. In this regard, the points are for a single use only. Although a useful system, one of the limitations of the existing program is that if the card is lost or stolen, unauthorized use is simple and does not protect the true owner of the card from unauthorized use. As a further significant limitation, recordal transactions or redemption transactions are not in real time.

A further example of existing technology consistent with the instant application is the points awarded by a credit card company. In this system, the credit card company allows a user to either accrue points for the purchase of goods and services, for example, a catalogue or alternatively, the points can be converted to airmiles where the purchase of an airline ticket may be facilitated. As in the case with the airmiles program, there are limitations to the credit card company systems. One of these limitations is that the user must either cash in the points for airline tickets or that from merchandise which has been pre-selected by the credit card company. In this regard, there is no real degree of freedom for the user in that it is confined to airmiles or pre-selected goods and services.

It would be desirable to have a system where vendors were linked with a system where merit or credit could be used for any good or service from any participating merchant or vendor on a world wide basis and where the merits had an actual value. The present invention addresses such a feature.

### SUMMARY OF THE INVENTION

One object of the present invention is to provide an electronic purchasing method, comprising the steps of an electronic purchasing method using redeemable points, comprising the steps of:

providing a customer card having user information program thereon;

providing a customer card reader for a merchant at a point of purchase for reading the user information, the reader being networked with a plurality of readers;

providing a central register having user information stored therein and connected to the network for access of the information;

providing bank information of the merchant accessible by information transmitted from the central register;

purchasing a good or service;

crediting or debiting a user with non-cash redeemable points;

forwarding debit or credit information to the central register through the reader; and

simultaneously debiting a merchant in cash a predetermined percentage of the taxed value of the purchase.

A significant feature of one embodiment of the proposed invention is to conduct business in real-time. This distinction, in part, contributes to the uniqueness of the system. The significance of this feature is to allow or provide the customer or user with the opportunity to utilize their points earned at any time regardless of when the points were accumulated. As an example, a user may collect points from one merchant and walk across the street to another merchant and utilize, as a redemption act, the points just previously earned.

Of particular benefit with the present system is the fact that the system can exist on its own or easily be integrated into existing banking networks or other debit/redemption networks.

Users or customers submit via the telephone, Internet, facsimile, mail or merchant an application required of all users or customers as a contract to participation in the network.

The users or customers access the operational features and programmed functions through the use of a card, much like existing bank cards. User or customer information held by the system is securely protected by encryption, etc. Users or customers select Personal Identification Numbers, (PIN), which is known only to the user or customer and will not be of known property or knowledge to parties involved in the operation and/or business of the system or merchant participants.

In terms of the merchants, they will offer the users or customers the opportunity to acquire points on the purchase of any goods or services, offered for sale by the participating merchant. Points will be earned by the users and customers through accumulation, based on a negotiated minimum percentage of the after tax total of monies paid to acquire a product or service offered by the merchant.

One of the major features or benefits of the present invention relates to the flexibility offered to the merchant to alter or tailor their individual program. This significant feature to the process will be facilitated through the use of a web-based initiative allowing the merchant sponsors the ability to tailor their programs daily. As an example, a merchant may discover that sales are down consistently on Tuesdays. The merchant may enter their program and choose to double the amount of points offered for Tuesday sales only.

As a further convenient feature, the merchant will offer the users or customers the opportunity to redeem points to pay in full or partial the monies owed for the purchase of any product or service offered for sale by the merchant participant. Points may be utilized for redemption, regardless of where they have been previously earned, through the accumulation process and are not exclusive to points earned at a specific and/or individual merchant participant.

Merchants will facilitate the operational features and programmed functions of the system through point of sale (POS) terminals. Merchants with conventional card reader equipment will not be required to upgrade their existing POS terminal hardware or software to access the features of the system. The system will advantageously operate on existing POS terminal technology.

The combined use of a card and merchant POS terminal permits both parties to carry out and participate in the system. By swiping the card through the merchant POS terminal, information is transmitted to and from the central register, which stores user or customer and merchant information and operational instructions. These programmable instructions allow the merchant and user or customer to complete individual transactions, whether they are accumulation or redemption routines.

Having thus generally described the present invention, reference will now be made to the accompanying drawing illustrating one embodiment of the process according to the present invention.

### DETAILED DESCRIPTION OF THE PREFERRED EMBODIMENTS

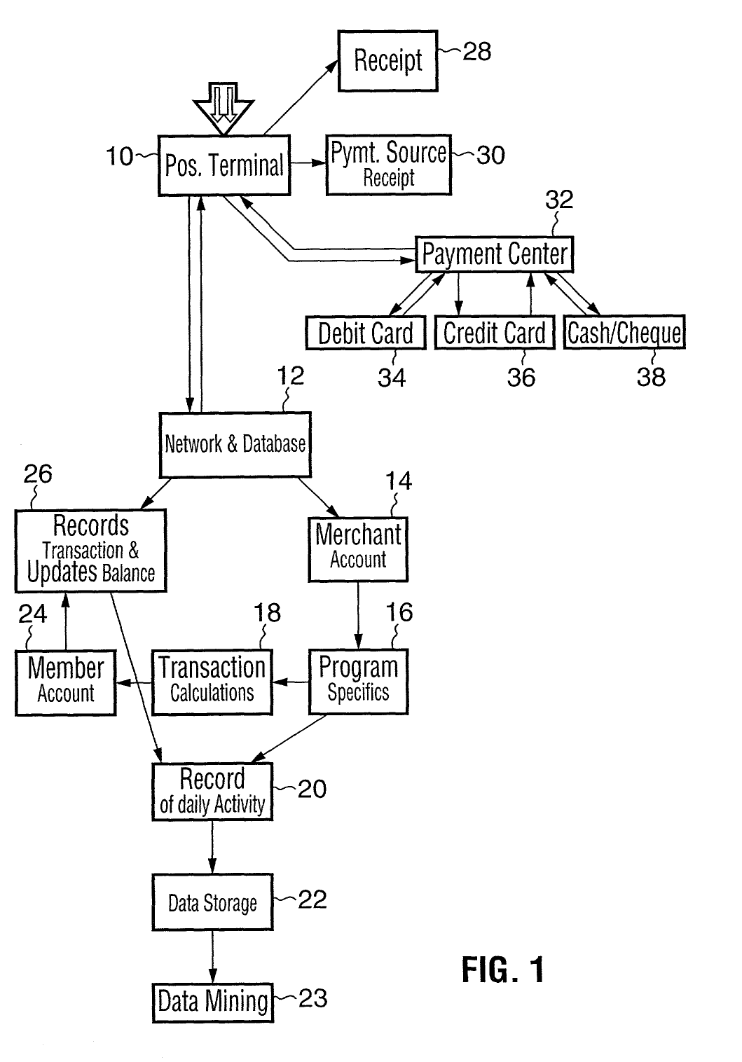

With reference to FIG. 1, shown is the first phase of the overall process for daily transactions and activity. In this process, the user and the merchant (neither of which is shown) have undertaken the sale and purchase of goods and/or services provided by the merchant and desired by the user. A purchase and sale price has been agreed upon and entered into the merchant's sales register (not shown). The merchant has recognized the purchasing party (the user) as a participant in the system and begins the transaction.

In order to begin the process, the user provides the merchant with the card (not shown) in order for the merchant to recognize membership. As is conventional, the merchant swipes the card through the point of sale (herein after referred to as POS) terminal, as is well known in the art.

The POS terminal is denoted by numeral 10 in FIG. 1 and once the card is swiped, the POS terminal, instructed by the information encoded on the card, opens communication between terminal 10 and the central register 12. The central register 12 holds all of the information related to the merchant and the user. At this point, the user is instructed by a suitable display means (not shown) which is well known in this field or POS terminal 10, to undertake one of two types of transactions; i) accumulation of points or ii) the redemption of points.

The input of a PIN is not required by the user on transactions in an accumulation situation.

Once communication has been established with the POS terminal 10 and the central register 12, central register 12 communicates with the merchant's account, globally denoted by numeral 14, which account is linked to the central register 12. In communication with account 14 are program specifics 16, which provides access to specific features/offerings of the particular merchant conducting the transaction. The program specifics also communicate with a transaction section 18, which calculates the amount of points for distribution to the user conducting the transaction. This information is then stored in a database 20. Database 20 further communicates with a second database 22, which logs the transactions occurring during the course of the day.

Subsequent to calculation in stage 18 of the process, the user's account is identified at 24 with the subsequent passage of this information to a records database 26, which records the transaction and the user's account. The user's account and balance are automatically updated in real-time at this point during the phase of the process.

The information is then conveyed back to the database 12 and subsequently on to terminal 10. The user is then provided with a printed receipt from a suitable printer, denoted by numeral 28, which indicates the total amount of points accumulated from the transaction, as well as the user's point account balance. At this point, the process using the methodology of the present invention is effectively complete. The only step that remains is conventional payment.

Data stored in database 22 will be available to merchants for data mining purposes 23. Conventional payment is achieved by making use of a payment source 30 with the source being in communication with a conventional payment center and the payment center in communication with a conventional debit card 34, credit card 36, or cheque 38.

With respect to steps 10 through 26, once the user's account is accessed, database 12 will determine if the user has the required amount of points to pay for the item in full or in part. If the required amount is available to pay in full, the database 12 will advise the user by displaying a message on the display means (not shown) of terminal 10. At this point, the user has the option of making an appropriate selection indicating that they wish to continue with the purchase where points are used as payment in full for the product or service. Following this selection, the database 12 will instruct terminal 10 to provide a receipt indicating the amount of points used and the user's remaining account balance. At this point, the transaction is complete.

As an alternative, the user may only have enough points to partially pay for the products and/or services being purchased. In this situation, the database 12 reports the dollar amount available for redemption and displays this message through the terminal 10 display means to the user. The user then decides whether to accept this alternative or go back to an accumulation situation and pay for the item through traditional means such as those indicated by steps 32 through 38. The user does not have the option to select the amount of points they wish to utilize towards the purchase.

The following examples are illustrative of the different situations that may occur and the respective transaction fees, settlement amounts, and calculations:

### EXAMPLE 1

The user purchases a computer from a merchant who offers an accumulation rate of 1%. The after-tax purchase amount is $2299.94. In this example, the user has decided to accumulate points and therefore, the user account is credited with 2299 points, and the merchant's bank account is debited $25.30. This amount of $25.30 is made up of 1% to cover the costs of points earned by the user and the transaction fee of 0.1% credited to the system. The merchant would collect full payment for the purchase through traditional means as indicated with respect the sequence of events denoted by numerals 32 through 38.

### EXAMPLE 2

The user purchases a computer from a merchant where the user wishes to utilize points to pay for the purchase in the amount of $2299.94. In this situation, the user has enough available points to cover the full cost of the computer under the fixed redemption rate of 1 point for every $0.01 of the purchase price. Accordingly, the user's account would be debited for 229,994 points. The merchant's bank account would be credited $2299.94 less the transaction fee of 1% ($22.99) for a total credit of $2276.95.

### EXAMPLE 3

The user purchases a computer from a merchant where the user wishes to redeem points to pay for the purchase in the amount of $2299.94. In this example, the database 12 determines that the user only has enough points to cover $2000.00 towards the purchase. At this point, the user has the option to choose to keep the points and accumulate them on the full purchase price paid through some other form of payment, such as that indicated with respect to the conventional route denoted by numerals 32 through 38. The user can also decide to redeem the points as a partial payment towards the computer. The user's account 24 is debited for the full amount available of 200,000 points. The merchant's account 14 would be credited in regard to points and the partial payment only, namely $2000.00 less the transaction fee of $20.00 for a total credit of $1980.00. The remaining balance of $299.94 would be paid to the merchant from the user utilizing traditional means of 32 through 38.

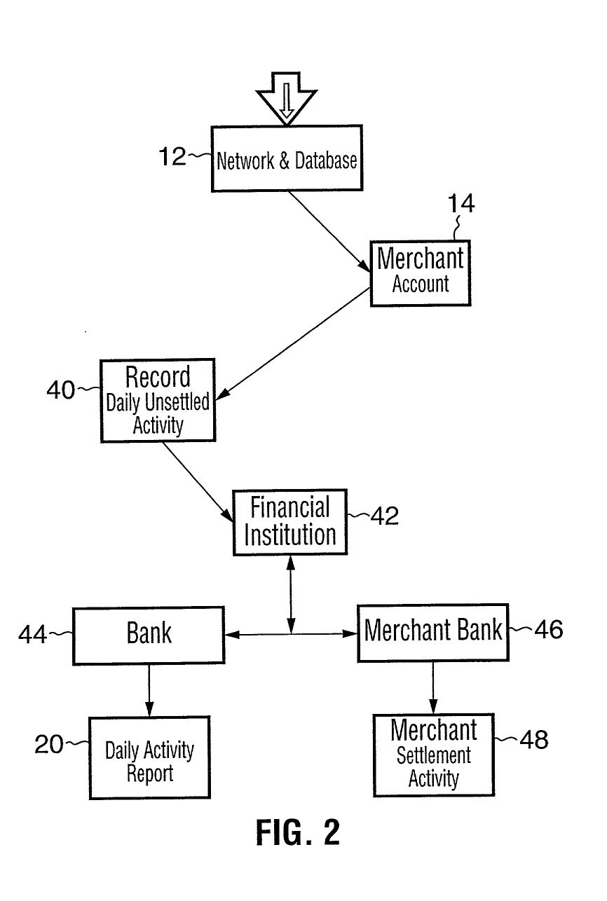

Turning to FIG. 2, shown is a process-flow diagram for the settlement phase of the operation.

The central register 12 will settle the net total of daily transactions at the end of each day through an automated collection system for each merchant. At an agreed upon time, the system will access each of the merchants' accounts 14 and in turn will identify the dollar amount of unsettled transactions recorded and maintained in the record of daily unsettled activity, represented by numeral 40.

In the example shown below, the net amount of unsettled dollar transactions at an accumulation offering of 1% by the participating merchant is tabulated.

| | Accumulation of Merit | | | Redemption of Merit (in full) | | |
|---|---|---|---|---|---|---|
| | Cost of | Fees to | | | Fees to | |
| Price of Item | Merit | Merit | Total Owed | Price Owed to | Merit | Total Owed to |
| Purchased | @ 1% | @ 0.1% | to Merit | Merchant | @ 1% | Merchant |
| $129.94 | $1.29 | $0.13 | $1.42 | | | |
| $3,245.00 | $32.45 | $3.25 | $35.70 | | | |
| $45.00 | | | | $45.00 | $0.45 | $44.55 |
| $367.00 | $3.67 | $0.37 | $4.04 | | | |
| $1,450.00 | $14.50 | $1.45 | $15.95 | | | |
| $12.00 | | | | $12.00 | $0.12 | $11.88 |
| $67.00 | $0.67 | $0.07 | $0.74 | | | |
| End of | $52.58 | $5.27 | $57.85 | $57.00 | $0.57 | $56.43 |
| Day Total | | | | | | |

| | |
|---|---|
| Net Total | Merit Receivable ($57.85) − Merchant Payable ($56.43) = |
| | $1.42 Owed to Merit |

Following the calculation of any unsettled activity, the central register 12 will automatically initiate contact with the merchant's financial institution, represented by numeral 42 and the selected bank account therein. Funds will then be transferred between the merchant account 46 and the system bank 44 for the net amount owed. Settlement transactions will be logged by date and the settlement details will be recorded and maintained in the central register 12.

The merchant will also have a bank file 46, which will be in communication with the system bank 44. As an option, the merchant may have a printout of daily activity by accessing a settlement activity file 48.

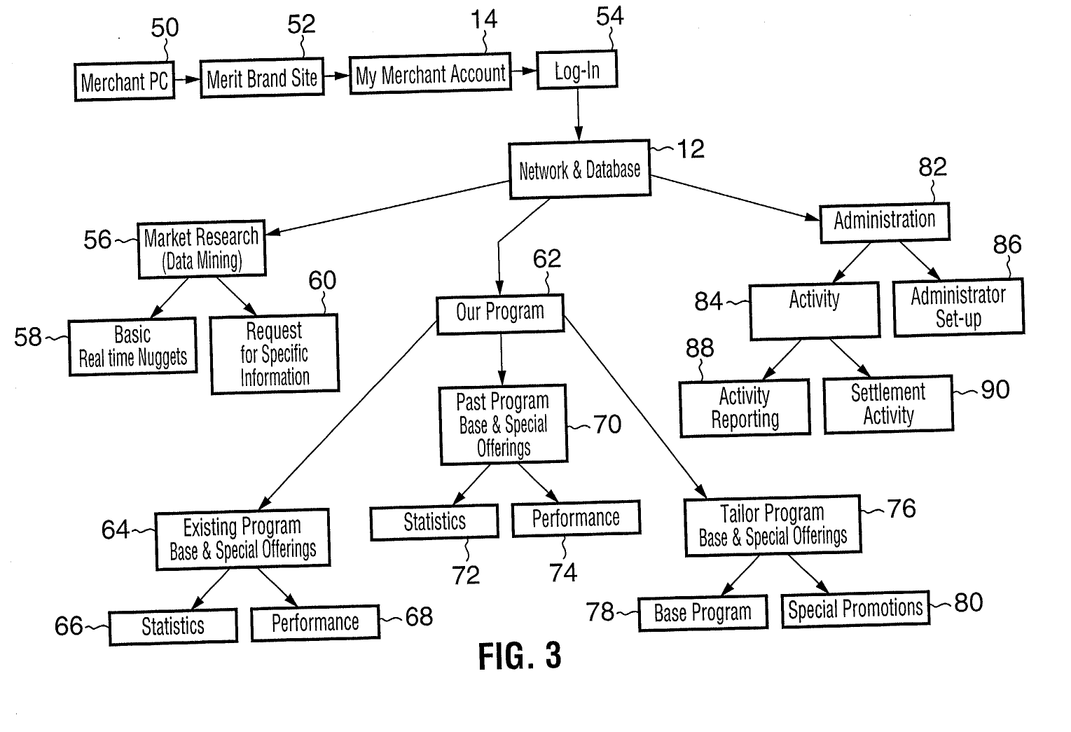

Referring now to FIG. 3, shown is the on-line features and access capabilities of the overall system.

The merchant can access the system through its PC 50 and subsequently access the system web-site 52 which in turn will lead to the merchant account 14 and eventually to the central register once the merchant logs in at 54.

Logging in is achieved by indicating the proper user name and password, which subsequently leads to the central register 12.

Once the central register 12 is accessed, the user may contact the market research file 56, which in turn provides access to a basic data mining service 58 or an in-depth data mining service 60.

As a further benefit and feature to the overall system, access can also be made to the overall program of the system 62 which provides further access to statistics and performance information relating to the merchant's offerings with a view to providing a measure of their success as it relates to the offerings and structure at 64, with a further breakdown of statistics 66, and performance 68. Similar information can be accessed with a past program 70, with statistics 72, and performance evaluations 74.

As a particularly useful feature in the overall method architecture, the merchant can access a program tailoring file 76 which facilitates alteration of the base program 78 offered by the merchant or special promotions 80. In this manner, the merchant has the capability to alter or tailor the offering subject to a minimum negotiated and/or special offerings (multiple points on certain days of the week, etc.) to suit his needs specifically in real-time. This is a significant feature of the overall process and not only benefits the merchant with the ability to immediately adapt to different market conditions, but also has the benefit of passing on significant benefit to the individual customer.

As will be appreciated, with all of the merchants on-line it will become evident to other merchants that a selected merchant with the best offer for points may realize a significant increase in business. This would therefore prompt other merchants to at least match or better the existing offers that they apparently have instituted to match the merchant who altered its program.

An administration database 82 is also provided to assist in a check and balance section of the network. The merchant is offered two basic sub-directories offering features. One of the directories is an activity directory 84 and an administrator setup directory 86 which facilitates the ability to add or terminate personnel access, personal username and password selection, changes in updates, security levels, etc. The activity directory 84 can also communicate with an activity reporting subdirectory 88 and a settlement activity directory 90. With respect to directory 88, activity may be defined by date and can be selected to be as broad or narrow to include specifics as to year, month, day, transaction, etc. Activity within this subdirectory relates to user activity only.

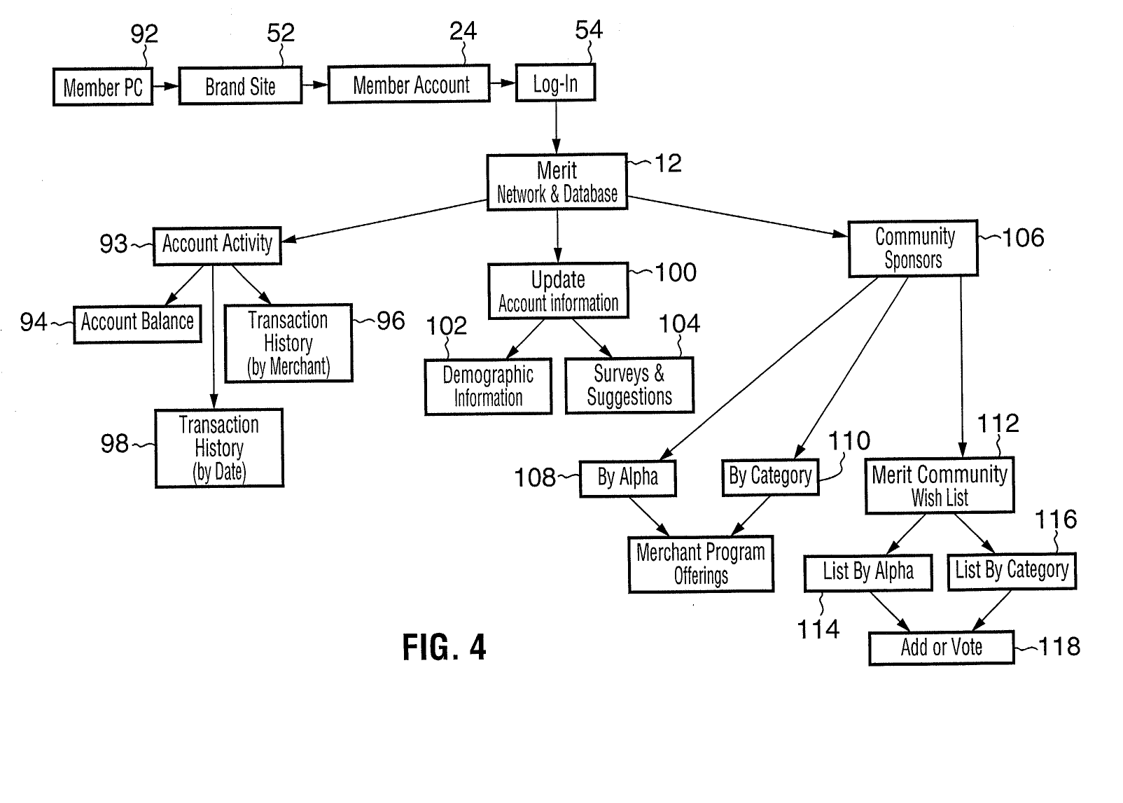

Referring now to FIG. 4, shown are the user on-line access and features in a process-flow diagram.

In a similar manner to that discussed for FIG. 3, a member or user connects to the system via a PC 92 and affects the same steps as those indicated in regard to FIG. 3 for accessing the central register 12.

Once the user is entered into the system, it may access a subdirectory for account activity 93 which provides details as to an account balance 94, transaction history directory 96, and transaction history by date 98. As a further option, there is a subdirectory 100, which allows the user to update any personal information necessary such as name, address, phone number, etc. This may be included in subdirectory 102. Also, in connection with directory 100 is a suggestions and surveys subdirectory 104 into which the user may enter information.

As a particularly convenient feature to the overall system, the community directory 106 is useful for the user or member to search member participants in a specific area, and more particularly, by alpha in a search directory 108 or by category in directory 110.

As a further significant convenience to this system, a further directory 112 is linked in the network for providing users with an opportunity to suggest merchants in a specific area that are not currently participating in the system. Users are able to view merchants that have been selected for participation by other users and can be viewed by alpha in directory 114 or by category in directory 116. Users can then vote for existing merchants or add new merchants by accessing subdirectory 118.

Although embodiments of the invention have been described above, it is not limited thereto and it will be apparent to those skilled in the art that numerous modifications form part of the present invention insofar as they do not depart from the spirit, nature, and scope of the claimed and described invention.

I/we claim:

1. An electronic purchasing method using redeemable points, comprising the steps of:
providing a customer card having user information program thereon;
providing a customer card reader for a merchant at a point of purchase for reading said user information, said reader being networked with a plurality of readers;
providing a central register having user information stored therein and connected to said network for access of said information;
providing bank information of said merchant accessible by information transmitted from said central register;
purchasing a good or service;
crediting or debiting a user with non-cash redeemable points;
forwarding debit or credit information to said central register through said reader; and
simultaneously debiting a merchant in cash a predetermined percentage of the taxed value of said purchase.

2. The electronic purchasing method of claim 1, further including the step of entering a password at said reader of allowing a user to access users information.

3. The electronic purchasing method of claim 1, further including the step of storing credit and debit information of said user in said central register.

4. The electronic purchasing method of claim 1, further including the step of determining the currency of a transaction.

5. The electronic purchasing method of claim 1, further including the step of printing a receipt of a transaction.

6. The electronic purchasing method of claim 1, further including the step of altering an amount of points attributed to a customer for a purchase by said merchant.

7. The electronic purchasing method of claim 1, further including the step of providing a customer with an option to purchase a good or service with cash or accrued points.

8. The electronic purchasing method of claim 7, wherein said accrued points are exhausted in entirety for purchasing a good or service.

9. The electronic purchasing method of claim 1, wherein said method is effected in real time.

10. The electronic purchasing method of claim 7, wherein accrued points are immediately available from said central register for use by said customer subsequent to a purchase.

11. The electronic purchasing method of claim 1, wherein said central register comprises a database.

12. The electronic purchasing method of claim 1, wherein said network comprises the interet.

13. An electronic purchasing method using redeemable points, comprising the steps of:
providing a customer card having user information program thereon;
providing a merchant at a point of purchase with means for conveying said user information over a network to a central register;
providing a central register having user information stored therein and connected to said network for access of said information;
providing bank information of said merchant accessible by information transmitted from said central register;
purchasing a good or service;
crediting or debiting a user with non-cash redeemable points;
forwarding debit or credit information to said central register through said means for conveying said user information;
simultaneously debiting a merchant in cash a predetermined percentage of the taxed value of said purchase; and
simultaneously crediting a customer with a predetermined amount of said non-cash redeemable points.

14. The electronic purchasing method of claim 13, wherein said non-cash redeemable points are immediately available for use by a customer for purchase of a good or service.

15. The electronic purchasing method of claim 13, further including the step of
providing a customer with an option to purchase said good or service with cash or said non-cash redeemable points.

16. The electronic purchasing method of claim 13, wherein said method is effected on the internet in real time.
